(19) United States
(12) Patent Application Publication
(10) Pub. No.: US 2026/0217037 A1
(43) Pub. Date: Jul. 30, 2026

(54) INKJET RECORDING APPARATUS

(71) Applicant: Konica Minolta, Inc., Tokyo (JP)

(72) Inventor: Keita SAITO, Osaka (JP)

(21) Appl. No.: 19/454,998

(22) Filed: Jan. 21, 2026

(30) Foreign Application Priority Data
Jan. 27, 2025 (JP) 2025-011187

(51) Int. Cl. B41J 2/19; B41J 2/17; B41J 2/175; B41J 2/18

(52) U.S. Cl. CPC B41J 2/19; B41J 2/1707; B41J 2/17596; B41J 2/18; B41J 2202/07

(57) ABSTRACT

An inkjet recording apparatus includes: a deaeration module capable of deaerating dissolved gas in ink; an inkjet head that ejects the ink deaerated by the deaeration module; and a hardware processor that predicts a malfunction of the deaeration module. In one embodiment, the inkjet recording apparatus further includes a sensor that senses a predetermined phenomenon related to the malfunction of the deaeration module, and the hardware processor predicts the malfunction of the deaeration module based on a sensing result of the sensor.

### CROSS-REFERENCE TO RELATED APPLICATION

The entire disclosure of Japanese Patent Application No. 2025-011187, filed on Jan. 27, 2025, including description, claims, drawings and abstract is incorporated herein by reference.

### BACKGROUND OF THE INVENTION

### Technical Field

The present disclosure relates to an inkjet recording apparatus.

### Description of Related Art

Conventionally, inkjet recording apparatuses that record an image by ejecting an ink droplet from an inkjet head onto a recording surface of a recording medium. In the inkjet recording apparatus, when a gas is dissolved in ink, the gas causes a problem are known.

In order to remove the gas dissolved in the ink, a deaeration module that deaerates the ink is provided on an ink supply route to the inkjet head. In the deaeration module, for example, a suction section connected to a gas permeable membrane via a vacuum path sucks air to depressurize the inside of the gas permeable membrane. Next, the ink comes into contact with the outer side of the gas permeable membrane of which the inside is depressurized, and thus the dissolved gas in the ink permeates the gas permeable membrane.

However, when a malfunction of the deaeration module occurs, the ink leaks from the gas permeable membrane to the vacuum path. When the leaked ink is cured in the vacuum path, it becomes difficult to reduce pressure in the gas permeable membrane by the suction section, and therefore, it becomes necessary to clean the vacuum path. In addition, when the leaked ink reaches the suction section through the vacuum path, the suction section malfunctions, and thus it is necessary to replace the suction section.

As the deaeration module, there are deaeration modules with other configurations in addition to the above-described configuration of depressurizing the inside of the gas permeable membrane. However, similarly to the deaeration module having the above-described configuration, when the malfunction occurs, it is necessary to perform cleaning of the vacuum path, replacement of the suction section, or replacement of the deaeration module.

In order to solve such problem, for example, WO 2016/098536 discloses a configuration in which a sensing section is provided in the middle of the vacuum path to sense inflow of the ink into the vacuum path due to the malfunction of the deaeration module.

However, the invention of WO 2016/098536 is configured to sense the inflow of the ink into the vacuum path. Therefore, it is necessary to stop driving the inkjet recording apparatus at the time of sensing the ink inflow and clean the vacuum path, which inevitably increases downtime. If a print job can be completed before the ink is cured in the vacuum path or reaches the suction section, it is unnecessary to stop driving the inkjet recording apparatus during the print job. However, even in such a case, downtime is increased due to the needs to clean the vacuum path after completion of the job.

Therefore, it is conceivable to perform an operation of replacing the deaeration module with a margin before the deaeration module malfunctions. However, since a replacement frequency becomes higher than that in a case where the deaeration module is replaced after the malfunction of the deaeration module, a new problem occurs such as costs required for the deaeration module increasing.

### SUMMARY OF THE INVENTION

The present disclosure has been made in view of such circumstances. An object of the present disclosure is to provide an inkjet recording apparatus in which a deaeration module can be replaced at an appropriate timing.

To achieve at least one of the abovementioned objects, according to one aspect of the present disclosure, an inkjet recording apparatus reflecting one aspect of the present disclosure includes, a deaeration module capable of deaerating dissolved gas in ink; an inkjet head that ejects the ink deaerated by the deaeration module; and a hardware processor that predicts a malfunction of the deaeration module.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present disclosure, and wherein:

FIG. 1 is a cross-sectional side view of an inkjet recording apparatus;

FIG. 2 is a schematic configuration diagram of a liquid delivery section in the inkjet recording apparatus;

FIG. 3 is a cross-sectional side view of a deaeration module according to a first embodiment;

FIG. 4 is a block diagram of the inkjet recording apparatus;

FIG. 5 is a flowchart of malfunction prediction processing;

FIG. 6 is a graph illustrating a sensing result of a sensing section in a malfunction prediction mode of the inkjet recording apparatus according to the first embodiment;

FIG. 7 is a cross-sectional side view of the deaeration module according to a second embodiment; and

FIG. 8 is a graph illustrating a sensing result of the sensing section in the malfunction prediction mode of the inkjet recording apparatus according to the second embodiment.

### DETAILED DESCRIPTION

Hereinafter, one or more embodiments of the present disclosure will be described with reference to the drawings. However, the scope of the invention is not limited to the disclosed embodiments.

Hereinafter, an inkjet recording apparatus according to an embodiment of the present disclosure will be described in detail with reference to the drawings. However, the scope of the invention is not limited to the illustrated examples. In the following description, components having the same functions and configurations are denoted by the same reference numerals, and the description thereof will be omitted.

### First Embodiment

### [Overall Configuration of Inkjet Recording Apparatus]

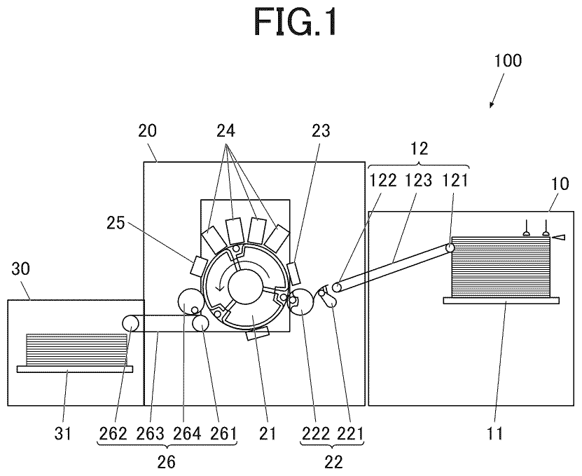

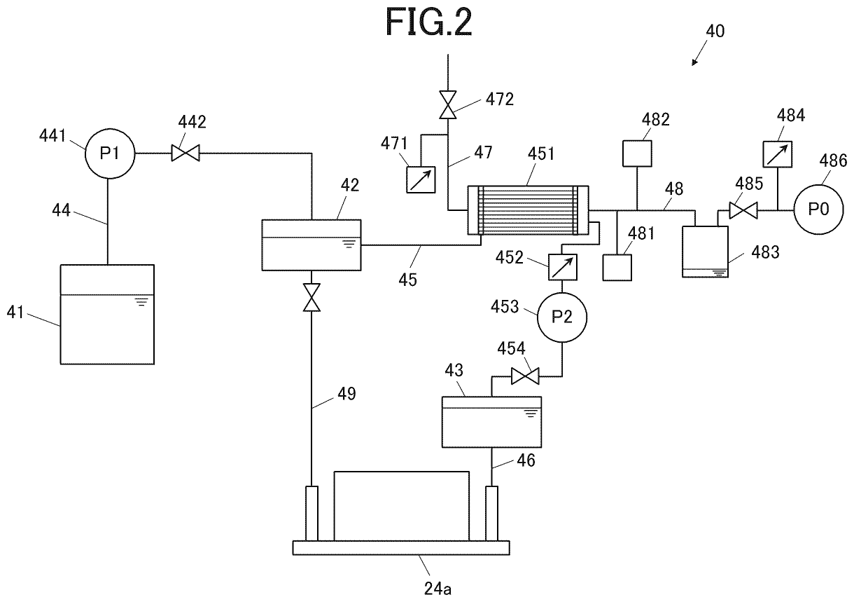

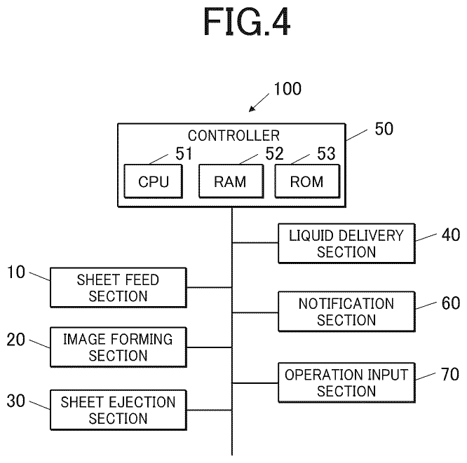

FIG. 1 is a cross-sectional side view which shows a main configuration of an inkjet recording apparatus 100 according to a first embodiment. The inkjet recording apparatus 100 includes, for example, a sheet feed section 10, an image forming section 20, a sheet ejection section 30, a liquid delivery section 40 (see FIG. 2), a controller 50 (hardware processor), a notification section (notifier) 60, and an operation input section 70 (see FIG. 4 for both).

The inkjet recording apparatus 100 conveys a recording medium from the sheet feed section 10 to the image forming section 20 based on the control of the controller 50. Then, the controller 50 causes the image forming section 20 to form an image on the recording medium with ink supplied from the liquid delivery section 40. After the image formation, the controller 50 ejects the recording medium to the sheet ejection section 30.

### (Sheet Feed Section)

The sheet feed section 10 stores the recording medium before image formation. The sheet feed section 10 conveys the recording medium to the image forming section 20 under the control of the controller 50. The sheet feed section 10 includes a sheet feed tray 11 and a conveyance section 12.

### {Sheet Feed Tray}

The sheet feed tray 11 is a plate member that stores the recording medium. The sheet feed tray 11 is provided so that one or a plurality of recording media can be placed thereon. The sheet feed tray 11 moves up and down in accordance with an amount of the recording medium placed thereon. By such vertical movement, the sheet feed tray 11 is held at a position where the uppermost recording medium is conveyed by the conveyance section 12.

### {Conveyance Section}

The conveyance section 12 conveys the recording medium from the sheet feed tray 11 to the image forming section 20. The conveyance section 12 includes a conveyance mechanism. The conveyance mechanism drives a belt 123 to convey the recording medium on the belt 123. The belt 123 has a ring shape, and the inner side of the ring is supported by a plurality of rollers 121 and 122. The conveyance section 12 delivers the uppermost recording medium placed on the sheet feed tray 11 onto the belt 123, and conveys the recording medium along the belt 123.

### (Image Forming Section)

The image forming section 20 records the image on the recording medium in cooperation with the liquid delivery section 40 under the control of the controller 50. The image forming section 20 includes an image forming drum 21, a handover unit 22, a sheet heating section 23, a head unit 24, an irradiation section 25, and a delivery section 26.

### {Image Forming Drum}

The image forming drum 21 carries the recording medium along a cylindrical outer periphery surface, and conveys the recording medium with rotation. A conveyance surface of the image forming drum 21 faces the sheet heating section 23, the head unit 24, and the irradiation section 25, and performs an image formation processing on the recording medium that is conveyed.

### {Handover Unit}

The handover unit 22 is provided in a position between the conveyance section 12 and the image forming drum 21. The handover unit 22 includes a claw 221 and a handover drum 222.

The claw 221 is a cylindrical member that holds one end of the recording medium conveyed by the conveyance section 12. The handover drum 222 is a member that guides the recording medium held by the claw 221.

The handover unit 22 picks up the recording medium on the conveyance section 12 with the claw 221, and places the recording medium along an outer periphery surface of the handover drum 222. The handover unit 22 hands over the recording medium to the image forming drum 21 by the operation.

### {Sheet Heating Section}

The sheet heating section 23 includes, for example, a heating wire and generates heat in response to energization. The sheet heating section 23 is controlled by the controller 50 to generate heat so that the recording medium passing through the vicinity thereof reaches a predetermined temperature. The sheet heating section 23 is provided in the vicinity of the outer periphery surface of the image forming drum 21 and on the upstream side of the head unit 24 in the conveyance direction of the recording medium.

A temperature sensor (not illustrated) is provided near the sheet heating section 23. With the temperature sensor, the controller 50 senses a temperature around the sheet heating section 23. Based on the sensed temperature, the controller 50 controls heat generation of the sheet heating section 23.

### {Head Unit}

The head unit 24 includes, for example, a plurality of inkjet heads 24a (refer to FIG. 2). The head unit 24 forms the image by ejecting ink droplets onto the recording medium from a nozzle. The head unit 24 corresponding to the colors of C (cyan), M (magenta), Y (yellow), and K (black) are provided for each color. In FIG. 1, the head unit 24 corresponding to the respective colors of Y, M, C, and K are provided in this order from the upstream with respect to the conveyance direction of the recording medium.

Here, a direction perpendicular to the conveyance direction of the recording medium in a plan view is defined as a main scanning direction. A plurality of head units 24 are provided to be arranged in the main scanning direction so as to have a length (width) that covers the entirety of the recording medium. That is, the inkjet recording apparatus 100 is a one-pass line-head type inkjet recording apparatus. The head unit 24 is configured by arranging a plurality of inkjet heads 24a which are droplet ejection heads. The number of the head units 24 may be equal to or greater than 5 or equal to or less than 3. Further, a single inkjet head 24 a may constitute the head unit 24.

The ink discharged by the head unit 24 is, for example, ultraviolet curable ink (UV ink). The ultraviolet curable ink contains, for example, an ultraviolet curable resin. The ultraviolet curable resin contains a monomer and a polymerization initiator. When the ink containing the ultraviolet curable resin is irradiated with ultraviolet rays, the monomer is polymerized and cured by the action of the polymerization initiator, and the ink is fixed to the recording medium.

The ink ejected by the head unit 24 may contain a gelling agent. The ink containing the gelling agent changes in phase between a gel state and a liquid (sol) state depending on the temperature. The ink containing the gelling agent has a phase change temperature of, for example, about 40 to 100° C., and is uniformly liquefied (solated) by being heated to a phase change temperature or higher. On the other hand, the ink containing the gelling agent is gelled at about normal room temperature, that is, about 0 to 30° C. Therefore, the ink in the head unit 24 is heated to an appropriate temperature by an ink heater or the like (not illustrated) to be brought into a sol state. Then, after the ink is ejected and the ink lands on the recording medium, the ink is moderately transferred to a gel state while the recording medium is conveyed by the image forming drum 21.

### {Irradiation Section}

The irradiation section 25 includes, for example, a fluorescent tube such as a low-pressure mercury lamp. The irradiation section 25 emits energy rays such as ultraviolet rays by light emission of the fluorescent tube. The irradiation section 25 is provided near the outer peripheral surface of the image forming drum 21. In addition, the irradiation section 25 is provided so as to be positioned on the downstream side of the head unit 24 in the conveyance direction of the recording medium. The irradiation section 25 irradiates the recording medium on which the ink has been ejected with energy rays. In a case where the ink on the recording medium is UV ink, the ink is cured by the action of the energy rays.

The fluorescent tube that emits ultraviolet rays is not limited to the low-pressure mercury lamp. The fluorescent tube may be a mercury lamp having an operating pressure of a few hundred Pa to 1 MPa, for example. The fluorescent tube may be a light source usable as a bactericidal lamp, for example, a cold-cathode tube, an ultraviolet laser light source, a metal halide lamp, a light-emitting diode, or the like. The fluorescent tube is desirably a power saving light source capable of emitting ultraviolet rays with higher illuminance. The fluorescent tube is, for example, the light-emitting diode. The energy rays are not limited to the ultraviolet rays and may be the energy rays having a property of curing the ink depending on the property of the ink. The light source is substituted depending on the energy rays.

In the above description, the case where the head unit 24 discharges the ultraviolet curable ink or the ink containing the gelling agent is exemplified, but the disclosure is not limited thereto. The ink ejected by the head unit 24 may be water-based ink or ink having other physical properties.

### {Delivery Section}

The delivery section 26 includes a conveyance mechanism. The conveyance mechanism drives a ring-shaped belt 263 whose inner side is supported by a plurality of rollers 261 and 262 to convey the recording medium. The delivery section 26 includes a cylindrical handover roller 264. The handover roller 264 hands over the recording medium from the image forming drum 21 to the conveyance mechanism. The delivery section 26 conveys the recording medium delivered onto the belt 263 by the handover roller 264, and sends it to the sheet ejection section 30.

### (Sheet Ejection Section)

The recording medium on which the image is formed by the image forming section 20 is ejected to the sheet ejection section 30. The sheet ejection section 30 includes a plate-shaped sheet ejection tray 31. The recording medium sent from the image forming section 20 by the delivery section 26 is placed on the sheet ejection tray 31. The sheet ejection section 30 stores the recording medium until the user takes out the recording medium.

### (Liquid Delivery Section)

FIG. 2 shows a schematic configuration diagram of the liquid delivery section 40. The liquid delivery section 40 includes a plurality of main tanks 41 that store the respective colors of ink. The liquid delivery section 40 supplies the ink of each color in the main tank 41 to the inkjet head 24a of each head unit 24. According to such control, the liquid delivery section 40 allows the ink of each color to be dischargeable from the nozzle.

As illustrated in FIG. 2, the liquid delivery section 40 includes a main tank 41, a first sub-tank 42, and a second sub-tank 43. The liquid delivery section 40 also includes a deaeration module 451 that removes gas dissolved in the ink before the ink is delivered to the head unit 24.

### <Main Tank>

The main tank 41 is a tank that stores ink to be supplied to each part of the liquid delivery section 40. The main tank 41 is, for example, a rigid sealed tank made of metal. The main tank 41 is connected to the first sub-tank 42 via a supply pipe 44.

### <First Sub-Tank>

The first sub-tank 42 is one or a plurality of ink inflow chambers having a smaller volume than the main tank 41. The ink pumped out of the main tank 41 by the supply pump 441 is stored in the first sub-tank 42. By providing the first sub-tank 42, pressure fluctuation due to pulsation when the supply pump 441 supplies the ink in the main tank 41 is alleviated. The first sub-tank 42 is connected to the second sub-tank 43 via a liquid delivery pipe 45.

The ink that is not discharged from the inkjet head 24a is collected into the first sub-tank 42 via a circulation channel 49 that provides communication between the outlet and the first sub-tank 42. By providing such circulation channel 49, it is possible to degas the dissolved gas in the ink by circulating the ink so as to pass through the deaeration module 451 from the first sub-tank 42 during maintenance. Note that the circulation channel 49 is not limited to the above-described configuration, and may be, for example, a channel that allows the liquid delivery pipe 45 and the first sub-tank 42 to communicate with each other.

### <Second Sub-tank>

The second sub-tank 43 is a small tank chamber that temporarily stores ink that has been deaerated by the deaeration module 451. The capacity of the second sub-tank 43 is substantially the same as that of the first sub-tank 42, for example. The second sub-tank 43 is connected to an inlet of each of the inkjet head 24a via a supply path 46. The ink in the second sub-tank 43 is supplied to each of the inkjet head 24a according to the amount of ink to be discharged from the nozzle. Further, the second sub-tank 43 is provided with a back pressure adjusting means (not illustrated) for preventing the ink from leaking out by applying an appropriate negative pressure to the inkjet head 24a.

### <Supply Pipe>

The supply pipe 44 is an ink channel that communicates with the main tank 41 and the first sub-tank 42. The supply pipe 44 is provided with a supply pump 441 and a supply valve 442. The supply pump 441 and the supply valve 442 operate under the control of the controller 50. The ink in the main tank 41 is supplied to the first sub-tank 42 via the supply pipe 44 by driving of the supply pump 441 when the supply valve 442 is opened. The entire main tank 41 is replaceable. Further, the main tank 41 can be attached to and detached from the supply pipe 44 regardless of the driving state of the supply pump 441.

### <Liquid Delivery Pipe>

The liquid delivery pipe 45 is an ink channel that allows the first sub-tank 42 and the second sub-tank 43 to communicate with each other. The liquid delivery pipe 45 is provided with a deaeration module 451, a flow rate sensor 452, a liquid delivery pump 453, a liquid delivery valve 454, and the like.

### <Deaeration Module>

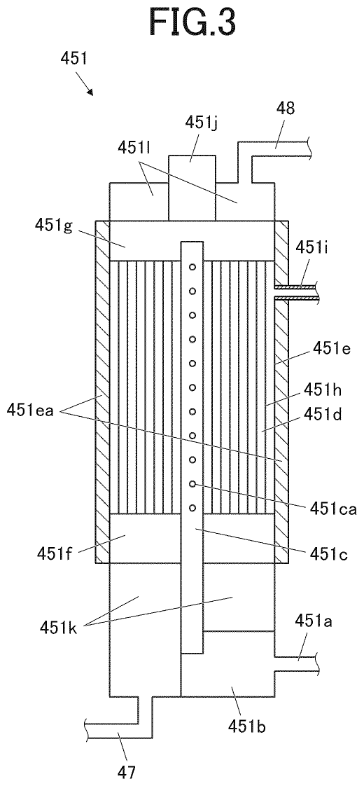

FIG. 3 shows an enlarged cross-sectional view of the deaeration module 451. The deaeration module 451 removes dissolved gas in the ink that has flowed thereinto, and discharges the deaerated ink. The deaeration module 451 includes, for example, an ink inflow port 451a, an ink inflow chamber 451b, a channel pipe 451c, a gas permeable membrane 451d, a housing 451e, a first sealing section (first sealer) 451f, a second sealing section (second sealer) 451g, an ink flow chamber 451h, an ink discharge port 451i, and a sensing section (sensor) 451j.

### {Ink Inflow Port, Ink Inflow Chamber}

The ink inflow chamber 451b is connected to the first sub-tank 42 via the ink inflow port 451a connected to the liquid delivery pipe 45. The ink inflow chamber 451b accepts inflow of the ink before deaeration from the first sub-tank 42.

### {Channel Pipe}

The channel pipe 451c has a substantially cylindrical shape, and is formed of metal having high thermal conductivity, such as SUS, aluminum, or copper. The channel pipe 451c is positioned substantially along a central shaft of the deaeration module 451. The channel pipe 451c has a first end connected to the ink inflow chamber 451b through the first sealing section 451f. The channel pipe 451c has a second end opposite to the first end and sealed by a second sealing section 451g, and includes a plurality of openings 451ca in its cylindrical lateral surface. Therefore, the channel pipe 451c allows the ink accepted from the ink inflow chamber 451b to flow out from the openings 451ca.

### {Gas Permeable Membrane}

The gas permeable membrane 451d has a tubular shape, and a film surface thereof has gas permeability. The gas permeable membrane 451d is, for example, a hollow fiber film and has a large number of hollow microfiber structures. In addition, the gas permeable membrane 451d is positioned along the central axis of the deaeration module 451 so as to surround the channel pipe 451c on the outer side of the channel pipe 451c. Therefore, the ink ejected from the openings 451ca is supplied to the periphery of the gas permeable membrane 451d.

The gas permeable membranes 451d communicate with the atmosphere via a first air chamber 451k in which the respective first ends of the gas permeable membranes 451d pass through the first sealing section 451f and are connected to a first vacuum path 47 described later. Further, the second ends of the gas permeable membranes 451d opposite to the respective first ends communicate with a vacuum pump 486 via a second air chamber 451l connected to a second vacuum path 48 described below through the second sealing sections 451g.

Note that the number of gas permeable membranes 451d provided in the deaeration module 451 is not particularly limited, but it is preferable to provide a large number of gas permeable membranes 451d so that the contact area between the ink and the gas permeable membranes 451d increase and the ink that flows to the ink discharge port 451i without contact with the gas permeable membranes 451d decreases.

The gas permeable membrane 451d is preferably made of, for example, silicone. This is because silicone has a high ability to transmit the dissolved gas in the ink. This is also because silicone has high heat resistance and ink resistance.

### {Housing}

The housing 451e forms a main body of the deaeration module 451, and as shown in FIG. 3, covers the outer side of the gas permeable membrane 451d. The housing 451e is made of metal having high thermal conductivity, such as SUS, aluminum, or copper. The housing 451e is provided with a heat source 451ea on the outer periphery, and is heated by heat supplied from the heat source 451ea to heat the ink inside.

### {First Sealing Section, Second Sealing Section, Ink Flow Chamber}

The first sealing section 451f and the second sealing section 451g are both made of, for example, epoxy resin, urethane resin, ultraviolet curable resin, or polyolefin resin (polyethylene, polypropylene, or the like). The first sealing section 451f and the second sealing section 451g fix both sides in the axis direction of the channel pipe 451c and the gas permeable membrane 451d, respectively, at predetermined positions. Furthermore, the first sealing section 451f and the second sealing section 451g restrain the ink having flowed into the ink flow chamber 451h from flowing into the first vacuum path 47 and the second vacuum path 48. Note that in the housing 451e, a space partitioned by the first sealing section 451f and the second sealing section 451g is an ink flow chamber 451h.

### {Ink Discharge Port}

The ink discharge port 451i is an opening portion provided in the ink flow chamber 451h, and discharges the ink, which is deaerated by contacting the gas permeable membrane 451d, to the second sub-tank 43.

### {Sensing Section}

The sensing section 451j senses a predetermined phenomenon related to a malfunction of the deaeration module 451, and transmits the above to the controller 50. The sensing section 451j according to the first embodiment is a pressure sensor that senses a contact load of the second sealing section 451g by a resistive film method. Note that when the sensing section 451j is a pressure sensor, the method of sensing the contact load of the second sealing section 451g is not limited to the resistive film method, but may be, for example, a capacitance method, a piezoelectric element method, an optical method, or the like. Note that the resistive film method is preferable because sensing configuration is simple and the number of components is small.

### <Flow Rate Sensor>

Returning to FIG. 2, the flow rate sensor 452 is provided in the vicinity of the deaeration module 451 on the liquid delivery pipe 45. The flow rate sensor 452 senses a flow rate of the ink flowing through the liquid delivery pipe 45 and transmits the flow rate to the controller 50. Note that FIG. 2 illustrates, as an example, the configuration in which the flow rate sensor 452 is provided on the downstream side of the deaeration module 451 in the liquid delivery direction, but the configuration is not limited thereto. The flow rate sensor 452 may be provided on the upstream side of the deaeration module 451 in the liquid delivery direction.

### <Liquid Delivery Pump, Liquid Delivery Valve>

The liquid delivery pump 453 and the liquid delivery valve 454 operate under the control of the controller 50. The liquid delivery pump 453 sends out, to the second sub-tank 43, the ink having flowed out from the ink discharge port 451i of the deaeration module 451 when the liquid delivery valve 454 is opened. A check valve (not illustrated) is provided between the liquid delivery pump 453 and the second sub-tank 43 to prevent backflow of the ink sent to the second sub-tank 43.

### <First Vacuum Path>

The first vacuum path 47 is an air channel that communicates with a first end of the deaeration module 451. The first vacuum path 47 is provided with a first pressure sensor 471, a first atmospheric valve 472, and the like.

### <First Pressure Sensor, First Atmospheric Valve>

The first pressure sensor 471 detects a pressure value of the first vacuum path 47 and transmits the pressure value to the controller 50. The first atmospheric valve 472 is an electromagnetic valve. The first atmospheric valve 472 opens or closes the first vacuum path 47 to the atmosphere in response to a control signal from the controller 50.

### <Second Vacuum Path>

The second vacuum path 48 is an air channel that communicates with a second end of the deaeration module 451. In the second vacuum path 48, a first trap 481, an ink leak sensing section 482, a second trap 483, a second pressure sensor 484, a second atmospheric valve 485, and a vacuum pump 486 are provided.

### <First Trap>

The first trap 481 stores, therein, liquid components that slightly leak from the gas permeable membrane 451d and enter the second vacuum path 48 in normal times.

### <Ink Leak Sensing Section>

The ink leak sensing section 482 senses the ink leaking from the gas permeable membrane 451d and the first trap 481 due to the malfunction of the deaeration module 451. Specifically, the ink leak sensing section 482 is formed of a photosensor, and includes a light emitting section and a light receiving section interposing the second vacuum path 48. The ink leak sensing section 482 senses the leakage of ink when a light receiving state changes due to ink adhering to the second vacuum path 48.

### <Second Trap>

The second trap 483 stores therein the liquid components that have not been trapped by the first trap 481 or the liquid components that have entered the second vacuum path 48 in a large amount due to breakage of the gas permeable membrane 451d. Therefore, the second trap 483 has a larger volume than the first trap 481, can also store a predetermined amount of gas, and can suppress a variation in the pressures in the gas permeable membranes 451d due to pulsation of the vacuum pump 486.

Note that the liquid component stored in the first trap 481 and the second trap 483 is a monomer, for example, when the ink is UV ink. Further, instead of providing the ink leak sensing section 482, a sensor for sensing the liquid amount in the second trap 483 may be provided.

### <Second Pressure Sensor, Second Atmospheric Valve>

The second pressure sensor 484 is provided between the second trap 483 and the vacuum pump 486 in the second vacuum path 48, and sequentially transmits the detected pressure value to the controller 50. The second atmospheric valve 485 is normally in a closed state, and is brought into an open state when the vacuum pump 486 is driven under the control of the controller 50.

### <Vacuum Pump>

The vacuum pump 486 is, for example, a diaphragm pump. Specifically, the vacuum pump 486 includes a pump chamber having an extendable diaphragm. In addition, the vacuum pump 486 includes a drive source or the like that operates the diaphragm so that the volume of the pump chamber expands and contracts. A pump chamber includes a suction port having the check valve that allows only inflow of a fluid from the outside. The pump chamber also includes a discharge port having the check valve that allows only outflow of the fluid from the inside.

The vacuum pump 486 sucks the atmosphere in the gas permeable membrane 451d when the second atmospheric valve 485 is opened, under the control of the controller 50. By the above-described operation of the vacuum pump 486, a foreign substance in the gas permeable membrane 451d is removed, and the pressure in the gas permeable membrane 451d is reduced. Therefore, in the ink which flows into the ink flow chamber 451h and comes into contact with an outer film surface of the gas permeable membrane 451d, a dissolved gas selectively permeates the film surface and is deaerated. Then, the dissolved gas that has passed through the gas permeable membrane 451d is discharged by the vacuum pump 486.

### (Controller)

FIG. 4 is a block diagram illustrating a configuration of the inkjet recording apparatus 100. The controller 50 controls each unit constituting the inkjet recording apparatus 100. As shown in FIG. 4, the controller 50 is connected to each unit constituting the inkjet recording apparatus 100. The controller 50 includes a central processing unit (CPU) 51, a random access memory (RAM) 52, a read only memory (ROM) 53 and the like.

### <CPU>

The CPU 51 reads various programs and data corresponding to processing contents from the storage device of the ROM 53 or the like and executes them. In addition, the CPU 51 controls the operation of each unit of the inkjet recording apparatus 100 according to the executed processing content. When the CPU 51 executes the program, the controller 50 functions as a malfunction prediction section that performs malfunction prediction processing to be described later.

### <RAM>

The RAM 52 temporarily stores therein the various programs and data processed by the CPU 51.

### <ROM>

The ROM 53 is a nonvolatile storage section such as a hard disk drive (HDD), a solid state drive (SSD), or a flash memory. The ROM 53 stores various programs and data, which are read by the CPU 51 or the like.

### (Notification Section)

The notification section 60 provides notification of various types of information under the control of the controller 50. The notification section 60 is, for example, a display part having a screen, a speaker that emits a predetermined sound, or a communication section that can communicate with other devices via a network.

### (Operation Input Section)

The operation input section 70 accepts various inputs related to the operation of the inkjet recording apparatus 100 according to the user's operation. The operation input section 70 includes, for example, a touch screen type input display device, up, down, left, and right movement keys for data selection, feed operation, and the like, various function keys, and the like. The operation input section 70 outputs a depression signal of a key depressed by the user or an operation signal of a mouse or the like to the CPU 51 of the controller 50.

### [Malfunction Prediction Processing]

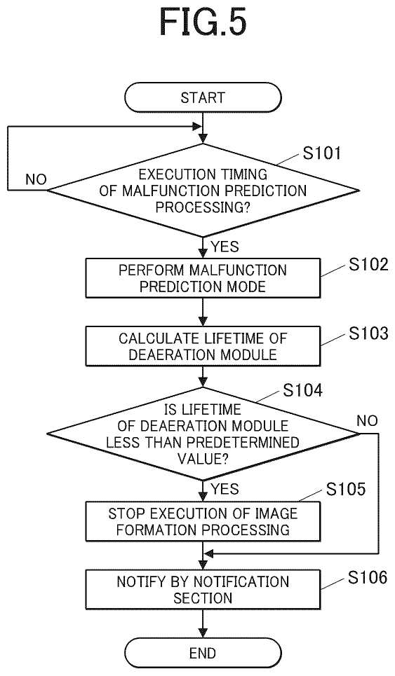

Malfunction prediction processing for the deaeration module 451 by the controller 50 according to the first embodiment will be described. FIG. 5 is a flowchart of malfunction prediction processing. Note that hereinafter, “malfunction prediction” refers to processing of sensing of a sign of a malfunction (in the present embodiment, breakage of the second sealing section 451g) of the deaeration module 451 before liquid components of the ink leak out to the second vacuum path 48 (more specifically, to the side of the vacuum pump 486 than the first trap 481).

First, the controller 50 determines whether or not it is the execution timing of the malfunction prediction processing (step S101). The controller 50 performs the malfunction prediction processing at any timing, for example, when accepting an instruction from the user, when an accumulated operating time of the inkjet recording apparatus 100 reaches a predetermined amount of time, or when a predetermined date and time set in advance comes. When it is not the execution timing of the malfunction prediction processing (step S101; No), the process transitions to step S101 and waits until it becomes the execution timing of the malfunction prediction processing.

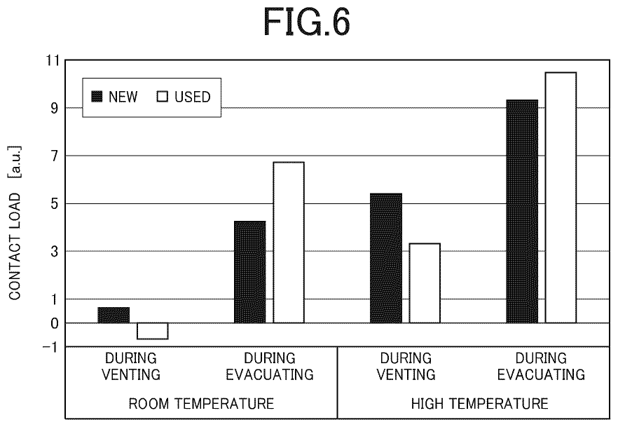

When it is the execution timing of the malfunction prediction processing (step S101; Yes), the controller 50 executes the malfunction prediction mode (step S102). The controller 50 senses the sign of the malfunction before the deaeration module 451 malfunctions based on the sensing result of the sensing section 451j. FIG. 6 is a graph illustrating, as an example of the sensing result of the sensing section 451j, a relative ratio between the contact loads sensed by the sensing section 451j in the new deaeration module 451 and the used (about to malfunction) deaeration module 451. In FIG. 6, for each deaeration module 451, a temperature state of the deaeration module 451 based on a driving state of the heat source 451ea and the sensing result when the driving state of the vacuum pump 486 is changed are shown. More specifically, in FIG. 6, the temperature is “high temperature” when the heat source 451ea is in the driving state, and is “room temperature” when the heat source 451ea is in the stopped state. In FIG. 6, a case where the vacuum pump 486 is in the driving state is “during evacuating”, and a case where the vacuum pump 486 is in the stopped state is “during venting”.

As illustrated in FIG. 6, a difference occurs in the sensing result of the sensing section 451j between the new deaeration module 451 and the used deaeration module 451. Therefore, the sensing result of the sensing section 451j in the used deaeration module 451 during the execution of the malfunction prediction mode is stored in the ROM 53 in advance. Then, the controller 50 acquires the sensing result of the sensing section 451j in the deaeration module 451 in use. The controller 50 can compare the acquired sensing result with the sensing result stored in the ROM 53 to calculate a period until the deaeration module 451 malfunctions (i.e., lifetime or replacement timing).

As shown in FIG. 6, when the heat source 451ea and the vacuum pump 486 are in a stopped state (i.e., at a room temperature state and during venting), the difference in the sensing result of the sensing section 451j is slight. On the other hand, in other cases, there is a certain difference in the sensing result of the sensing section 451j. In particular, when the heat source 451ea is in the driving state (high temperature state) and the vacuum pump 486 is in the stopped state (during venting), the difference in the sensing result between the new product and the used product is the largest, and the sensing accuracy is also the highest. Therefore, for example, it is particularly preferable that the controller 50 considers the state where the heat source 451ea is in the driving state and the vacuum pump 486 is in the stopped state as the malfunction prediction mode and acquires the sensing result by the sensing section 451j in this state. The controller 50 executes such a malfunction prediction mode during execution of an image recording process or a maintenance process (for example, a process of circulating ink so as to pass through the circulation channel 49 or the like) except during standby of the inkjet recording apparatus 100.

The controller 50 calculates the lifetime of the deaeration module 451 based on the sensing result of the sensing section 451j (step S103). Then, the controller 50 determines whether the calculated lifetime of the deaeration module 451 is less than a predetermined value (step S104).

When the lifetime of the deaeration module 451 is less than the predetermined value (step S104; Yes), that is, when the deaeration module 451 is about to malfunction, it is necessary to prevent the deaeration module 451 from malfunctioning and the second vacuum path 48 (particularly, the vacuum pump 486) from being contaminated. Therefore, the controller 50 turns off the power of the inkjet recording apparatus 100. Alternatively, the controller 50 does not accept the image forming operation by the inkjet recording apparatus 100. Alternatively, the controller 50 stops the image forming operation being performed. In this way, the controller 50 stops the image forming section 20 so as not to perform the image formation processing (step S105).

Thereafter, the controller 50 notifies the calculation result of the lifetime of the deaeration module 451 including the calculated period until the malfunction, the replacement timing, and the like by the notification section 60 (step S106). Note that in a case where the notification section 60 is a communication section that causes another device to provide a notification by communicating with the other device, the notification section 60 may provide the notification to a component ordering system. According to the configuration, it is possible to efficiently replace the deaeration module 451.

In a case where the lifetime of the deaeration module 451 is the predetermined value or more (step S104; No), the controller 50 transitions to step S106 and notifies the calculation result of the lifetime of the deaeration module 451 by the notification section 60.

### Second Embodiment

Next, an inkjet recording apparatus 100 according to a second embodiment will be described. In the following description, the same components as those of the inkjet recording apparatus 100 according to the first embodiment are denoted by the same reference numerals, and detailed description thereof will be omitted.

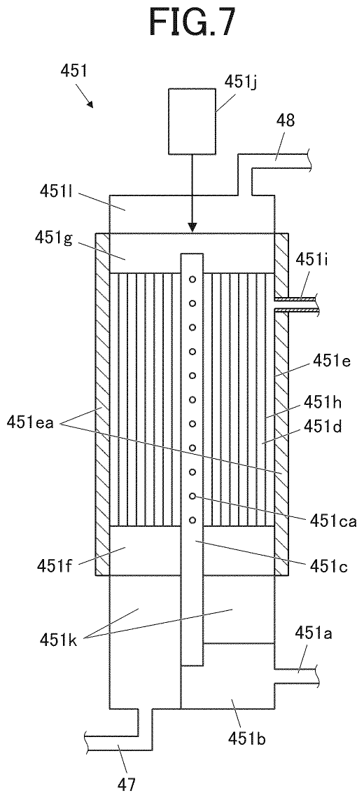

As illustrated in FIG. 7, the inkjet recording apparatus 100 according to the second embodiment is different from the inkjet recording apparatus 100 according to the first embodiment in that the sensing section 451j is an optical displacement sensor provided immediately above the deaeration module 451. The sensing section 451j senses the displacement of the second sealing section 451g by irradiating, with infrared light, a window provided in the deaeration module 451 and having a filter to cut UV light.

Note that FIG. 7 illustrates, as an example, the structure in which the sensing section 451j is disposed on a straight line parallel to the axis direction of the deaeration module 451, but the structure is not limited thereto. In a case where there is no space for arranging the sensing section 451j on a straight line parallel to the axis direction of the deaeration module 451, the sensing section 451j may be arranged at a position further separated from the deaeration module 451 by using a mirror.

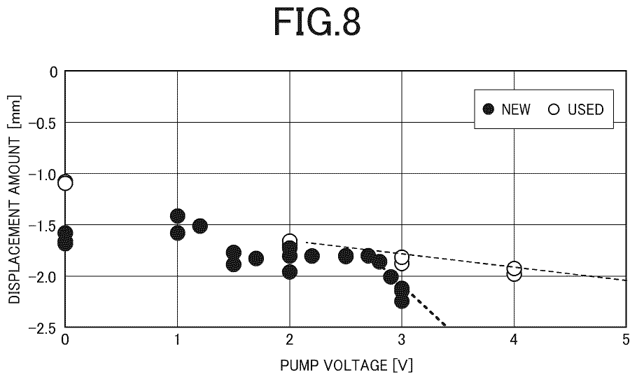

FIG. 8 is an example of a graph illustrating the sensing result of the new deaeration module 451 and the used deaeration module 451 by the sensing section 451j according to the second embodiment. In FIG. 8, an X-axis represents a drive voltage of the liquid delivery pump 453 at the time of sensing by the sensing section 451j (that is, the amount of ink fed), and a Y-axis represents the sensing result of the sensing section 451j (that is, the amount of deformation of the second sealing section 451g).

As illustrated in FIG. 8, when the drive voltage becomes around 3V, the amount of change (i.e., the slope) in the sensing result by the sensing section 451j with respect to the amount of change in the drive voltage changes so as to increase in the new liquid delivery pump 453. On the other hand, in the used liquid delivery pump 453, the slope does not change much even when the drive voltage of the liquid delivery pump 453 is increased to more than 3V. This is because, normally when the ink feed amount increases, the suction amount of the vacuum pump 486 also increases, and hence the displacement amount of the second sealing section 451g also increases, whereas when the leak exists in the second sealing section 451g, the displacement amount decreases.

Therefore, similarly to the first embodiment, the controller 50 stores, in advance in the ROM 53, the amount of change in the sensing result by the sensing section 451j relative to the amount of change in the liquid delivery pump 453 in the used deaeration module 451. Then, the controller 50 acquires the sensing result of the sensing section 451j at each timing while changing the drive voltage of the liquid delivery pump 453 as the malfunction prediction mode at a predetermined timing. The controller 50 can calculate the period until the deaeration module 451 malfunctions by comparing the acquired sensing result with the sensing result stored in the ROM 53.

In the above description, a configuration in which the sensing section 451j senses the displacement of the second sealing section 451g has been exemplified, but the present disclosure is not limited thereto. For example, in a case where the second sealing section 451g is displaced, the gas permeable membrane 451d is also displaced correspondingly, and therefore, the sensing section 451j may sense the displacement of the gas permeable membrane 451d and calculate, based on the sensing, the period until the deaeration module 451 malfunctions. Similarly, the sensing section 451j may sense changes in the volumes of the ink flow chamber 451h and the second air chamber 451l and calculate, based on the changes, the period until the deaeration module 451 malfunctions.

### Other Configurations

The scope of the present disclosure is not limited to the above-described embodiments, but encompasses the scope of the invention described in the claims and equivalents thereof.

For example, in the above description, a case where the sensing section 451j is the pressure sensor or the displacement sensor has been exemplified, but the present disclosure is not limited thereto. For example, when the second air chamber 451l is displaced and its volume changes, the temperature of the second vacuum path 48 and the pressure difference between the first air chamber 451k and the second air chamber 451l also change. Therefore, known temperature sensors that sense the temperature of the second vacuum path 48 and the first and second pressure sensors 471 and 484 that sense the pressures of the first air chamber 451k and the second air chamber 451l may be used as the sensing section 451j.

In addition, in a case where the second sealing section 451g is about to be broken and the deformation amount is reduced, the deformation amount of the ink flow chamber 451h is also reduced, and the flow rate of the ink on the downstream side in the liquid delivery direction is reduced with respect to the upstream side in the liquid delivery direction of the deaeration module 451. Therefore, the flow rate sensor 452 may be provided not only on the downstream side but also on the upstream side in the liquid delivery direction of the deaeration module 451, and these may be used as the sensing section 451j.

Furthermore, a predetermined excitation mechanism that excites the second sealing section 451g may be provided, and a vibration sensor that senses a vibration of the second sealing section 451g may be used as the sensing section 451j. Furthermore, known temperature sensors that sense the temperature of the deaeration module 451 and the temperature of the ink flowing through the deaeration module 451 may be used as the sensing section 451j.

In addition, in the above description, various sensing sections 451j are exemplified, but the sensing section 451j is not limited to any one of the forms described above, and a plurality of sensing sections 451j may be provided, and a malfunction of the deaeration module 451 may be predicted in a composite manner from information acquired by the controller 50. Similarly, the information used is not limited to the sensing result of the sensing section 451j, and the controller 50 may predict the malfunction of the deaeration module 451 by compositely using operation information related to an operation history such as a print volume (PV), the number of accumulated operation days, a total liquid delivery amount, a total degassing circulating time, a total driving time of the vacuum pump 486, and the like.

In addition, in the above description, a case where the deaeration module 451 is a so-called external reflux type in which the inner side of the gas permeable membrane 451d is in a vacuum state and the ink is circulated to the outer side thereof is exemplified, but the invention is not limited thereto. The deaeration module 451 may be of a so-called internal reflux type in which the ink is refluxed to the hollow portion of the gas permeable membrane 451d, or may be of another type.

According to the present disclosure, the deaeration module can be replaced at an appropriate timing.

Although embodiments of the present disclosure have been described and illustrated in detail, the disclosed embodiments are made for purposes of illustration and example only and not limitation. The scope of the present disclosure should be interpreted by terms of the appended claims.

What is claimed is:

1. An inkjet recording apparatus comprising:
a deaeration module capable of deaerating dissolved gas in ink;
an inkjet head that ejects the ink deaerated by the deaeration module; and
a hardware processor that predicts a malfunction of the deaeration module.

2. The inkjet recording apparatus according to claim 1,
further comprising a sensor that senses a predetermined phenomenon related to the malfunction of the deaeration module,
wherein the hardware processor predicts the malfunction of the deaeration module based on a sensing result of the sensor.

3. The inkjet recording apparatus according to claim 2,
further comprising a vacuum path which is connected to the deaeration module and through which the dissolved gas deaerated by the deaeration module flows,
wherein the hardware processor predicts the malfunction of the deaeration module when no ink is present in the vacuum path.

4. The inkjet recording apparatus according to claim 2, wherein the sensor senses a state of a predetermined member included in the deaeration module.

5. The inkjet recording apparatus according to claim 4, wherein,
the deaeration module includes a gas permeable membrane that deaerates the dissolved gas in the ink, and a sealer that fixes an end of the gas permeable membrane to a predetermined position, and
the sensor senses a displacement of the sealer.

6. The inkjet recording apparatus according to claim 4, wherein,
the deaeration module includes a gas permeable membrane that deaerates the dissolved gas in the ink, and a sealer that fixes an end of the gas permeable membrane to a predetermined position, and
the sensor senses a contact load of the sealer.

7. The inkjet recording apparatus according to claim 6, wherein the sensor senses the contact load of the sealer by a resistive film method.

8. The inkjet recording apparatus according to claim 4, wherein,
the deaeration module includes a gas permeable membrane that deaerates the dissolved gas in the ink, and a sealer that fixes an end of the gas permeable membrane to a predetermined position, and
the sensor senses a vibration when the sealer is vibrated.

9. The inkjet recording apparatus according to claim 4, wherein the sensor senses a temperature of the deaeration module.

10. The inkjet recording apparatus according to claim 4, wherein the sensor senses an ink temperature.

11. The inkjet recording apparatus according to claim 4,
further comprising a vacuum path which is connected to the deaeration module and through which the dissolved gas deaerated by the deaeration module flows,
wherein,
the deaeration module includes a gas permeable membrane that deaerates a dissolved gas in the ink, a first air chamber that is connected to a first end of the gas permeable membrane, and a second air chamber that is connected to a second end opposed to the first end of the gas permeable membrane and that is connected to the vacuum path, and
the sensor senses a pressure difference between the first air chamber and the second air chamber.

12. The inkjet recording apparatus according to claim 4,
further comprising a vacuum path which is connected to the deaeration module and through which the dissolved gas deaerated by the deaeration module flows,
wherein the sensor senses a temperature of the vacuum path.

13. The inkjet recording apparatus according to claim 4, wherein the sensor senses a flow rate of the ink upstream and downstream of the deaeration module in a liquid delivery direction.

14. The inkjet recording apparatus according to claim 4, wherein the hardware processor predicts the malfunction based on the sensing result of the sensor and operation information related to an operation history of the deaeration module.

15. The inkjet recording apparatus according to claim 1, wherein the hardware processor executes a malfunction prediction mode in which the malfunction of the deaeration module is predicted in a case in which a predetermined condition is established.

16. The inkjet recording apparatus according to claim 15, wherein the hardware processor executes the malfunction prediction mode in a case in which an input of an instruction to execute the malfunction prediction mode is accepted from a user, in a case in which an accumulated operating time reaches a predetermined amount of time, or in a case in which a current date and time reaches a predetermined date and time.

17. The inkjet recording apparatus according to claim 15,
further comprising a circulation channel through which the ink having passed through the deaeration module is circulated to an upstream side of the deaeration module in a liquid delivery direction,
wherein the hardware processor executes the malfunction prediction mode while the ink is circulating in the circulation channel.

18. The inkjet recording apparatus according to claim 1, wherein the hardware processor performs any one among control of turning off a power source, control of stopping ink ejection of the inkjet head, control of stopping start of ink ejection, and control of notifying a result of malfunction prediction based on a prediction result.

19. The inkjet recording apparatus according to claim 1, further comprising a notifier that notifies a prediction result by the hardware processor.

20. The inkjet recording apparatus according to claim 19, wherein the notifier notifies at least one of a malfunction timing and a replacement timing of the deaeration module.
